(19) United States
(12) Patent Application Publication
(10) Pub. No.: US 2005/0041573 A1
(43) Pub. Date: Feb. 24, 2005

(54) Ranging method in a broadband wireless access communication system

(75) Inventors: Kwang-Seop Eom, Seongnam-si (KR); Bong-Gee Song, Seoul (KR); Min-Hee Cho, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/909,245

(22) Filed: Jul. 30, 2004

(30) Foreign Application Priority Data
Jul. 30, 2003 (KR) 2003-52894

(51) Int. Cl. H04J 11/00

(52) U.S. Cl. 370/208

(57) ABSTRACT

A method for transmitting a ranging code from a base station to subscriber stations to prevent collision during a random access by the subscriber stations in an Orthogonal Frequency Division Multiplexing/Orthogonal Frequency Division Multiple Access (OFDM/OFDMA) communication system. The method includes allocating connection identifiers (CIDs) for identifying the subscriber stations, allocating group IDs to the CIDs to divide the subscriber stations into a predetermine number of groups, and allocating ranging codes for distinguishing subscriber stations in a group corresponding to each of the allocated group IDs.

### PRIORITY

This application claims priority under 35 U.S.C. § 119 to an application entitled “Ranging Method in a Broadband Wireless Access Communication System” filed in the Korean Intellectual Property Office on Jul. 30, 2003 and assigned Serial No. 2003-52894, the contents of which are incorporated herein by reference.

### BACKGROUND OF THE INVENTION

1. Field of the Invention

The present invention relates generally to an uplink access method in a Broadband Wireless Access (BWA) communication system, and in particular, to a method for transmitting a ranging code in a mobile communication system supporting Orthogonal Frequency Division Multiple Access (OFDMA).

2. Description of the Related Art

In a 4^{th} generation (4G) communication system, which is a next generation communication system, active research is being conducted on technology for providing users with various qualities of service (QoSs) at a data rate of about 100 Mbps. The current 3^{rd} generation (3G) communication system generally supports a data rate of about 384 Kbps in an outdoor channel environment having a relatively poor channel environment, and supports a data rate of a maximum of 2 Mbps in an indoor channel environment having a relatively good channel environment.

A wireless local area network (LAN) system and a wireless metropolitan area network (MAN) system generally support a data rate of 20 to 50 Mbps. Therefore, in the current 4G communication system, active research is being carried out on a new communication system securing mobility and QoS for the wireless LAN system and the wireless MAN system supporting a relatively high data rate, in order to support the high-speed services that the 4G communication system aims to provide.

A communication system proposed in Institute of Electrical and Electronics Engineers (IEEE) 802.16a performs a ranging operation between a subscriber station (SS) and a base station (BS), for communication.

FIG. 1 is a diagram schematically illustrating a configuration of an Orthogonal Frequency Division Multiplexing/Orthogonal Frequency Division Multiple Access (OFDM/OFDMA) Broadband Wireless Access (BWA) communication system. More specifically, FIG. 1 illustrates a configuration of an IEEE 802.16a/IEEE 802.16e communication system.

However, before a description of FIG. 1 is given, in the description, it is presumed that the wireless MAN system is a BWA communication system, and is broader in service area and higher in data rate than the wireless LAN system. A communication system employing OFDM/OFDMA to support a broadband transmission network for a physical channel of the wireless MAN system is called an “IEEE 802.16a OFDM/OFDMA communication system.” That is, an IEEE 802.16a communication system corresponds to the OFDM/OFDMA BWA communication system.

The IEEE 802.16a communication system enables high-speed data transmission by transmitting a physical channel signal using multiple subcarriers. In addition, the IEEE 802.16e communication system corresponds to a communication system considering mobility of a subscriber station in the IEEE 802.16a communication system. Currently, there has been provided no specification for the IEEE 802.16e communication system. Therefore, both the IEEE 802.16a communication system and the IEEE 802.16e communication system correspond to the OFDM/OFDMA BWA communication system, and for the convenience of explanation, the IEEE 802.16a and IEEE 802.16e OFDM/OFDMA communication systems will be described herein below. Although the IEEE 802.16a communication system and the IEEE 802.16e communication system can utilize a Single Carrier instead of OFDM/OFDMA, it will be assumed herein that OFDM/OFDMA is used.

Referring to FIG. 1, the IEEE 802.16a/IEEE 802.16e communication system has a multicell configuration, and includes a base station 100 and a plurality of subscriber stations 110, 120, and 130, all of which are managed by the base station 110. Signal exchange between the base station 110 and the subscriber stations 110, 120, and 130 is accomplished using OFDM/OFDMA.

OFDMA can be defined as a two-dimensional access method, which is a combination of Time Division Access (TDA) and Frequency Division Access (FDA). Therefore, when data is transmitted by OFDMA, OFDMA symbols are separately carried by subcarriers and transmitted over predetermined subchannels. The “subchannel” is a channel including a plurality of subcarriers, and in a communication system supporting OFDMA, i.e., an OFDMA communication system, each subchannel includes a predetermined number of subcarriers according to system conditions.

FIG. 2 is a diagram schematically illustrating a frame configuration of an OFDMA communication system. Referring to FIG. 2, a horizontal axis represents OFDM symbol numbers, and a vertical axis represents subchannel numbers. One OFDMA frame includes a plurality of OFDMA symbols, e.g., 8, and each OFDM symbol includes a plurality of subchannels, e.g., N. Further, each OFDMA frame includes a plurality of ranging slots, e.g., 4. Reference numeral 201 represents ranging regions, or ranging slots, in an M^{th} frame, and reference numeral 202 represents ranging slots in an (M+1)^{th} frame.

A ranging channel includes at least one subchannel, and unique numbers of the subchannels included in the ranging channel are included in an uplink (UL)-MAP message. The ranging channel is a logical channel using ranging regions in a frame, and Initial Ranging, Periodic Ranging, and Bandwidth Request Ranging are performed through the ranging channel. The ranging slots are provided by dividing the ranging channel in a time axis, and are classified into initial ranging slots, periodic ranging slots, and bandwidth request ranging slots.

The UL-MAP message is a message representing uplink frame information, and includes an ‘Uplink Channel ID’ representing an uplink channel identifier (ID) in use, a ‘UCD Count’ representing a count corresponding to a change in configuration of an Uplink Channel Descript (UCD) message having an uplink burst profile, and a ‘Number of UL-MAP Elements n’ representing the number of elements following the UCD Count. The uplink channel identifier is uniquely allocated in a Media Access Control (MAC) sublayer. That is, the OFDMA communication system attempts to distribute all subcarriers used therein, in particular, data subcarriers over the entire frequency band, to thereby acquire frequency diversity gain.

In addition, the OFDMA communication system needs a ranging process for adjusting a correct time offset to a transmission side, or a base station, and a reception side, or a subscriber station, and controlling power.

FIG. 3 is a diagram schematically illustrating a downlink frame configuration for an OFDM/OFDMA BWA communication system, particularly, illustrating a downlink frame configuration for an IEEE 802.16a/IEEE 802.16e communication system. Referring to FIG. 3, a downlink frame 300 includes a preamble field 310, a Frame Control Header (FCH) field 320, and a plurality of DL burst fields (DL burst #1 to DL burst #m) 330 to 340. The preamble field 310 transmits a synchronization signal, or a preamble sequence, for synchronizing a base station and a subscriber station.

The FCH field 320 includes a DL Frame Prefix field 321, a field 323 including a Downlink Channel Descript (DCD), a UCD, and MAPs, and a padding field 325. The MAPs include a downlink (DL)-MAP including information on a downlink frame and UL-MAP including information on an uplink frame.

The DL-MAP field is a field in which a DL-MAP message is transmitted. Information Elements (IEs) included in the DL-MAP message are shown in Table 1 below.

TABLE 1

| Syntax | | Size | Notes |
|---|---|---|---|
| DL-MAP_Message_Format( ) { | | | |
| | Management Message Type = 2 | 8 bits | |
| | PHY Synchronization Field | Variable | See appropriate PHY specification. |
| | DCD Count | 8 bits | |
| | Base Station ID | 48 bits | |
| | Number of DL-MAP Elements n | 16 bits | |
| | Begin PHY Specific Section { | | See applicable PHY section. |

| | |
|---|---|
| for (i = 1; i <= n; i++) { | For each DL-MAP element l to n. |

| | | |
|---|---|---|
| DL_MAP_Information_Element( ) | Variable | See corresponding PHY specification. |
| if !(byte boundary) { | | |

| | | |
|---|---|---|
| Padding Nibble | 4 bits | Padding to reach byte boundary. |

}

}

}

}

As illustrated in Table 1, a DL-MAP message includes a plurality of IEs of ‘Management Message Type’ representing a type of a transmission message, a ‘PHY Synchronization Field’ being set according to a modulation scheme and a demodulation scheme employed for a physical (PHY) channel for acquiring synchronization, a ‘DCD Count’ representing a count corresponding to a change in configuration of a message including a downlink burst profile, a ‘Base Station ID’ representing a Base Station Identifier (BSID), and a ‘Number of DL-MAP Elements n’ representing the number of elements following the Base Station ID. Though not illustrated in Table 1, the DL-MAP message includes information on ranging codes allocated separately to rangings described herein below.

The UL-MAP field is a field for which a UL-MAP message is transmitted. IEs included in the UL-MAP message are shown in Table 2.

TABLE 2

| | |
|---|---|
| Syntax | Size |

UL_MAP_Message_Format( ) {

| | |
|---|---|
| Management Message Type=3 | 8 bits |
| Uplink channel ID | 8 bits |
| UCD Count | 8 bits |
| Number of UL_MAP Elements n | 16 bits |
| Allocation Start Time | 32 bits |
| Begin PHY Specific Section { | |

for(i=1; i<n; i+n)

| | |
|---|---|
| UL_MAP_Information_Element { | Variable |

Connection ID
UIUC
Offset

}

}

}

}

As shown in Table 2, a UL-MAP message includes a plurality of IEs of ‘Management Message Type’ representing a type of a transmission message, an ‘Uplink Channel ID’ representing an uplink channel ID in use, a ‘UCD Count’ representing a count corresponding to a change in configuration of a UCD message having an uplink burst profile, and a ‘Number of UL-MAP Elements n’ representing the number of elements following the UCD Count. The uplink channel identifier is uniquely allocated in a MAC sublayer.

In Table 2, an Uplink Interval Usage Code (UIUC) field records therein information for designating a usage of an offset recorded in an Offset field. For example, if ‘2’ is recorded in the UIUC field, it indicates that a Starting offset used for initial ranging is recorded in the Offset field. If ‘3’ is recorded in the UIUC field, it indicates that a Starting offset used for bandwidth request ranging or maintenance ranging is recorded in the Offset field. The Offset field, as stated above, records therein a time offset value used for initial ranging and bandwidth request ranging or maintenance ranging based on the information recorded in the UIUC field. In addition, information on a characteristic of a physical channel to be transmitted in the UIUC field is recorded in the UCD message.

If the subscriber station has failed to perform successful ranging, it determines a particular backoff value in order to increase success probability at a next attempt, and makes another ranging attempt after a lapse of the backoff time. Information necessary for determining the backoff value is also included in the UCD message. A configuration of the UCD message will be described in detail herein below with reference to Table 3.

TABLE 3

| | | |
|---|---|---|
| Syntax | Size | Notes |

UCD-Message_Format( ) {

| | |
|---|---|
| Management Message Type=0 | 8 bits |
| Uplink channel ID | 8 bits |
| Configuration Change Count | 8 bits |
| Mini-slot size | 8 bits |
| Ranging Backoff Start | 8 bits |
| Ranging Backoff End | 8 bits |
| Request Backoff Start | 8 bits |
| Request Backoff End | 8 bits |
| TLV Encoded Information for the overall channel | Variable |
| Begin PHY Specific Section { | |

for(i=1; i<n; i+n)

| | |
|---|---|
| Uplink_Burst_Descriptor | Variable |

}

}

}

As illustrated in Table 3, the UCD message includes a plurality of IEs of ‘Management Message Type’ representing a type of a transmission message, an ‘Uplink Channel ID’ representing an uplink channel ID in use, a ‘Configuration Change Count’ counted in a base station, a ‘Mini-slot Size’ representing a size of mini-slots in an uplink physical channel, a ‘Ranging Backoff Start’ representing a start point of a backoff for initial ranging, i.e., representing a size of an initial backoff window for initial ranging, a ‘Ranging Backoff End’ representing an end point of a backoff for initial ranging, i.e., representing a size of a final backoff window, a ‘Request Backoff Start’ representing a start point of a backoff for contention data and requests, i.e., representing a size of a first backoff window, and a ‘Request Backoff End’ representing an end point of a backoff for contention data and requests, i.e., representing a size of a final backoff window.

The backoff value represents a kind of a waiting time for which a subscriber station should wait for a next ranging when it has failed in rangings as described below. When the subscriber station fails in ranging, the base station must transmit to the subscriber station the backoff value, which is information on a time for which it must wait for a next ranging.

In addition, the DL burst fields 330 to 340 correspond to time slots uniquely allocated to subscriber stations by TDM/TDMA (Time Division Multiple Access). The base station transmits broadcasting information to be broadcasted to subscriber stations managed by the base station through a DL-MAP field of the downlink frame using a center carrier.

At a power-on, the subscriber stations monitor all frequency bands previously uniquely set thereto, and detect a pilot channel signal having a highest power, e.g., a highest carrier to interference and noise ratio (CINR). A subscriber station determines a base station that transmitted a pilot channel signal having the highest CINR as its base station to which it currently belongs, and detects control information for controlling its uplink and downlink and information representing actual data transmission/reception points by analyzing a DL-MAP field and a UL-MAP field of the downlink frame transmitted by the base station.

FIG. 4 is a diagram schematically illustrating a configuration of an uplink frame for an OFDM/OFDMA BWA communication system, particularly, illustrating an uplink frame configuration for an IEEE 802.16a/IEEE 802.16e communication system. However, before a description of FIG. 4 is given, a description will be made of rangings used in the IEEE 802.16a/IEEE 802.16e communication system, i.e., Initial Ranging, Maintenance Ranging (or Periodic Ranging), and Bandwidth Request Ranging.

As described above, rangings used in the IEEE 802.16a/IEEE 802.16e communication system can be classified into the following three ranges according to their objects.

1. Initial Ranging

2. Bandwidth Request Ranging

3. Periodic Ranging (or Maintenance Ranging)

Objects of the three rangings are defined in the IEEE 802.16a communication system. The IEEE 802.16a communication system, because it employs OFDM/OFDMA, needs ranging subchannels and ranging codes for the ranging procedure, and a base station allocates allowable ranging codes according to objects, or types, of rangings.

1. Initial Ranging

The initial ranging is performed to synchronize a subscriber station and a base station at the request of the base station. The initial ranging is performed to adjust a correct time offset between the subscriber station and the base station and to control transmission power. That is, the subscriber station receives a DL-MAP message and a UL-MAP/UCD message upon power-on to acquire synchronization with the base station, and then performs the initial ranging in order to adjust the time offset with the base station and transmission power. The base station receives a MAC address of the subscriber station from the subscriber station through the initial ranging procedure. The base station generates a basic connection ID (CID) mapped to the MAC address of the subscriber station, and a primary management CID, and transmits the generated basic CID and primary management CID to the subscriber station. The subscriber station recognizes its own basic CID and primary management CID through the initial ranging procedure.

The IEEE 802.16a/IEEE 802.16e communication system, because it employs OFDM/OFDMA, needs subchannels and ranging codes for the ranging procedure. A base station allocates available ranging codes according to objects, or types, of the rangings.

The ranging code is generated by segmenting a pseudo-random noise (PN) sequence having a predetermined length of, for example, (2¹⁵−1) bits on a predetermined unit basis. Generally, two ranging subchannels having a length of 53 bits constitute one ranging channel, and a PN code is segmented through a ranging channel having a length of 106 bits to generate ranging codes. Of the configured ranging codes, a maximum of 48 ranging codes RC#1 to RC#48 can be allocated to subscriber stations, and as a default value, a minimum of 2 ranging codes per subscriber station are applied to the rangings of the 3 objects, i.e., initial ranging, periodic ranging and bandwidth request ranging. Accordingly, different ranging codes are separately allocated to the rangings of the 3 objects.

For example, N ranging codes are allocated for the initial ranging (N RCs (Ranging Codes) for initial ranging), M ranging codes are allocated for the periodic ranging (M RCs for maintenance ranging), and L ranging codes are allocated for the bandwidth request ranging (L RCs for BW-request ranging). The allocated ranging codes, as described above, are transmitted to subscriber stations through a UCD message, and the subscriber stations perform a ranging procedure by using ranging codes included in the UCD message according to their objects.

FIG. 5 is a diagram illustrating a structure of a ranging code generator for generating ranging codes in a conventional OFDMA communication system. Referring to FIG. 5, the ranging codes are generated by segmenting a PN sequence having a predetermined length on a predetermined unit basis as described above. The PN sequence generator, or a ranging code generator, of FIG. 5 has a generation polynomial of 1+x¹+x⁴+x⁷+x¹⁵.

Further, the ranging code generator includes a plurality of memories 510 mapped to respective terms of the generation polynomial, and an exclusive OR (XOR) operator 520 for performing an XOR operation on values output from the memories corresponding to respective taps of the generation polynomial.

In the OFDMA communication system, as described above, one ranging channel includes two ranging subchannels, each subchannel including 53 subcarriers, and uses 106-bit ranging codes. Each subscriber station randomly selects any one of the ranging codes, and performs a ranging procedure using the randomly selected ranging code.

The ranging code is modulated for subcarriers in the ranging channel on a bit-by-bit basis by Binary Phase Shift Keying (BPSK), before being transmitted. Therefore, the ranging codes have a characteristic showing no correlation between them. As a result, even though the ranging codes are transmitted at the same time, a receiver can distinguish the ranging codes.

2. Periodic Ranging

The periodic ranging represents ranging periodically performed to adjust a channel status with a base station by a subscriber station that adjusted a time offset with the base station and transmission power through the initial ranging. The subscriber station performs the periodic ranging using ranging codes allocated for the periodic ranging.

3. Bandwidth Request Ranging

The bandwidth request ranging is ranging used to request bandwidth allocation to actually perform communication with a base station by a subscriber station that adjusted a time offset with the base station and transmission power through the initial ranging.

Referring to FIG. 4, an uplink frame 400 includes an initial ranging contention slot field 410 allocated for initial ranging and periodic ranging, a bandwidth request contention slot field 420 allocated for bandwidth request ranging, and a plurality of uplink burst fields 430 to 440 including uplink data of subscriber stations. The initial ranging contention slot field 410 has a plurality of access burst periods, each including actual initial ranging and periodic ranging, and a collision period in case that collision occurs between a plurality of access burst periods. The bandwidth request contention field 420 includes a plurality of bandwidth request periods, including an actual bandwidth request ranging, and a contention period in case that collision occurs between a plurality of bandwidth request rangings. Each of the uplink burst fields 430 to 440 includes a plurality of burst regions (an SS#1 scheduled data region to an SS#n scheduled data region) such that the uplink data can be separately transmitted by the subscriber stations. Each of the burst regions includes a preamble 431 and an uplink burst 433.

FIG. 6 is a diagram schematically illustrating a communication procedure through the messages described in connection with FIGS. 3 and 4 in a BWA communication system. Referring to FIG. 6, upon a power-on, a subscriber station (SS) 620 monitors all frequency bands previously set in the subscriber station 620, and detects a pilot channel signal having a highest power, e.g., a highest carrier to interference and noise ratio (CINR). The subscriber station 620 determines a base station 600 that transmitted a pilot channel signal having the highest CINR as its base station to which it currently belongs, and acquires system synchronization with the base station 600 by receiving a preamble of a downlink frame transmitted from the base station 600.

If system synchronization between the subscriber station 620 and the base station 600 is acquired in this way, the base station 600 transmits a DL-MAP message and a UL-MAP message to the subscriber station 620 in Steps 601 and 603. The DL-MAP message, as described in connection with Table 1, provides the subscriber station 620 with information for synchronizing the base station 600 and the subscriber station in a downlink, and informing on a configuration of a physical channel capable of receiving messages transmitted to respective subscriber stations in the downlink based on the necessary information. The UL-MAP message, as described in conjunction with Table 2, provides the subscriber station 620 with information on a scheduling period of the subscriber station and a configuration of a physical channel in an uplink.

The DL-MAP message is periodically transmitted from the base station 600 to all subscriber stations, and if the subscriber station 620 can continuously receive the DL-MAP message, then the subscriber station 620 is synchronized with the base station 600. That is, subscriber stations receiving the DL-MAP message can receive all messages transmitted over a downlink.

As described with reference to Table 3, when the subscriber station 620 fails in access, the base station 600 transmits the UCD message including information of an available backoff value to the subscriber station 620.

To perform the ranging, the subscriber station 620 sends a ranging request (RNG-REQ) message to the base station 600 in step 605, and the base station 600 receiving the RNG-REQ message sends a ranging response (RNG-RSP) message including information for correcting the above-stated frequency, time, and transmission power, to the subscriber station 620 in Step 607.

A configuration of the RNG-REQ message is shown in Table 4 below.

TABLE 4

| | | |
|---|---|---|
| Syntax | Size | Notes |

RNG-REQ_Message_Format( ) {

| | | |
|---|---|---|
| Management Message Type = 4 | 8 bits | |
| Downlink Channel ID | 8 bits | |
| Pending Until Complete | 8 bits | |
| TLV Encoded Information | Variable | TLV specific |

}

As shown in Table 4, ‘Downlink Channel ID’ represents a downlink channel identifier (ID) included in the RNG-REQ message that is received by the subscriber station 620 through the UCD. ‘Pending Until Complete’ represents priority of a ranging response being transmitted. For example, ‘Pending Until Complete’=0 means that a previous ranging response has higher priority, and ‘Pending Until Complete’≠0 means that a current ranging response has higher priority.

In addition, a configuration of the RNG-RSP message responsive to the RNG-REQ message is shown below in Table 5.

TABLE 5

| | | |
|---|---|---|
| Syntax | Size | Notes |

RNG-RSP_Message_Format( ) {

| | | |
|---|---|---|
| Management Message Type = 5 | 8 bits | |
| Uplink Channel ID | 8 bits | |
| TLV Encoded Information | Variable | TLV specific |

}

As shown in Table 5, an ‘Uplink channel ID’ is an uplink channel ID included in the RNG-REQ message.

In the IEEE 802.16a OFDMA communication system, the RNG-REQ can also be replaced by providing a dedicated ranging period such that the rangings can be efficiently performed and transmitting a ranging code.

FIG. 7 is a diagram schematically illustrating a communication procedure in an OFDM/OFDMA BWA communication system. Referring to FIG. 7, a base station 700 transmits a DL-MAP message and a UL-MAP message to a subscriber station 720 in Steps 701 and 703, in the manner described in connection with FIG. 6. In the OFDMA communication system, in Step 705, the subscriber station 720 transmits a Ranging Code, instead of the RNG-REQ message used in FIG. 6, and the base station 700 receiving the Ranging Code transmits an RNG-RSP message to the subscriber station 720 in Step 707.

New information must be added such that information on the Ranging Code transmitted to the base station 700 can be recorded in the RNG-RSP message. The new information that must be added to the RNG-RSP message includes:

1. Ranging Code: received ranging CDMA code

2. Ranging Symbol: OFDM symbol in the received ranging CDMA code

3. Ranging Subchannel: ranging subchannel in the received ranging CDMA code

4. Ranging Frame Number: frame number in the received ranging CDMA code

In the IEEE 802.16a OFDMA communication system, 48 ranging codes, each having a length of 106 bits, are divided into three groups, and the three groups are separately used for initial ranging, periodic ranging, and bandwidth request ranging. A time period for which one ranging code is transmitted is called a “ranging slot.” In an initial ranging process, one ranging slot includes two symbols, and in periodic ranging and bandwidth request ranging processes, one ranging slot includes one symbol.

Initial Ranging Procedure

FIG. 8 is a flow diagram illustrating an initial ranging procedure in an OFDM/OFDMA BWA communication system. Referring to FIG. 8, upon power-on, a subscriber station 820 monitors all frequency bands previously set in the subscriber station 820, and detects a pilot channel signal having a highest power, e.g., a highest carrier to interference and noise ratio (CINR). The subscriber station 820 determines a base station 800 that transmitted a pilot channel signal having the highest CINR as its base station to which it currently belongs, and acquires system synchronization with the base station 800 by receiving a preamble of a downlink frame transmitted from the base station 800.

If system synchronization between the subscriber station 820 and the base station 800 is acquired in this way, the base station 800 transmits a DL-MAP message to the subscriber station 820 (not shown). The DL-MAP message includes a ‘PHY Synchronization’ being set according to a modulation scheme and a demodulation scheme employed for a physical (PHY) channel for acquiring synchronization, a ‘DCD Count’ representing a count corresponding to a change in configuration of a DCD message including a downlink burst profile, a ‘Base Station ID’ representing a Base Station Identifier (BSID), a ‘Number of DL-MAP Elements n’ representing the number of elements following the Base Station ID, and information on ranging codes allocated separately to the rangings.

After transmitting the DL-MAP message, the base station 800 transmits a UCD message to the subscriber station 820 (not shown). The UCD message includes an ‘Uplink Channel ID’ representing an uplink channel ID in use, a ‘Configuration Change Count’ counted in a base station, a ‘Mini-slot Size’ representing a size of mini-slots in an uplink physical channel, a ‘Ranging Backoff Start’ representing a start point of a backoff for initial ranging, i.e., representing a size of an initial backoff window for initial ranging, a ‘Ranging Backoff End’ representing an end point of a backoff for initial ranging, i.e., representing a size of a final backoff window, a ‘Request Backoff Start’ representing a start point of a backoff for contention data and requests, i.e., representing a size of an initial backoff window, and a ‘Request Backoff End’ representing an end point of a backoff for contention data and requests, i.e., representing a size of a final backoff window. The Request Backoff Start corresponds to MIN_WIN representing a minimum window size for an exponential random backoff algorithm described herein below, and Request Backoff End corresponds to MAX_WIN representing a maximum window size for the exponential random backoff algorithm. The exponential random backoff algorithm will be described in more detail below.

The backoff value represents a kind of a waiting time for which a subscriber station should wait for a next ranging when it failed in a previous ranging. When the subscriber station fails in ranging, the base station must transmit to the subscriber station the backoff value, which is information on a time for which it must wait for a next ranging. If it is assumed that a backoff value for a case where the subscriber station fails in ranging is k, the subscriber station transmits a next ranging code after waiting for a ranging slot by a value randomly selected from [1,2^{k}]. The backoff value k is increased up to the Ranging Backoff End value from the Ranging Backoff Start value one by one each time a ranging attempt is made.

After transmitting the UCD message, the base station 800 transmits a UL-MAP message to the subscriber station 820 in Step 801. Upon receiving the UL-MAP message from the base station 800, the subscriber station 820 can recognize ranging codes used for the initial ranging, information on a modulation scheme and a demodulation scheme, a ranging channel, and a ranging slot. The subscribe station 820 randomly selects one ranging code from the ranging codes used for the initial ranging, randomly selects one ranging slot from the ranging slots used for the initial ranging, and transmits the selected ranging code to the base station 800 through the selected ranging slot in Step 803. Transmission power used for transmitting the ranging code in step 803 has a minimum transmission power level.

If the subscriber station 820 fails to receive a separate response from the base station 800 even though it transmitted the ranging code, the subscriber station 820 once again randomly selects one ranging code from the ranging codes used for the initial ranging, randomly selects one ranging slot from the ranging slots used for the initial ranging, and transmits the selected ranging code to the base station 800 through the selected ranging slot in Step 805. Transmission power used for transmitting the ranging code in step 805 is higher in power level than the transmission power used for transmitting the ranging code in step 803. Of course, if the subscriber station 820 receives from the base station 800 a response to the ranging code transmitted in step 803, step 805 can be skipped.

Upon receiving a random ranging code through a random ranging slot from the subscriber station 820, the base station 800 transmits to the subscriber station 820 a ranging response (RNG-RSP) message including information indicating successful receipt of the ranging code, for example, an OFDMA symbol number, a subchannel, and a ranging code in Step 807.

Although not illustrated in FIG. 8, upon receiving the RNG-RSP message, the subscriber station 820 adjusts time and frequency offsets and transmission power using the information included in the RNG-RSP message. In addition, the base station 800 transmits a UL-MAP message including CDMA Allocation IE for the subscriber station 820 to the subscriber station 820 in Step 809. The CDMA Allocation IE includes information on an uplink bandwidth at which the subscriber station 820 will transmit a ranging request (RNG-REQ) message.

The subscriber station 820 receiving the UL-MAP message from the base station 800 detects CDMA Allocation IE included in the UL-MAP message, and transmits an RNG-REQ message including a MAC address to the base station 800 using uplink resource, or the uplink bandwidth, included in the CDMA Allocation IE in Step 811. The base station 800 receiving the RNG-REQ message from the subscriber station 820 transmits an RNG-RSP message including connection IDs (CIDs), i.e., a basic CID and a primary management CID, to the subscriber station 820 according to a MAC address of the subscriber station 820 in Step 813.

After performing the initial ranging procedure in the manner described in conjunction with FIG. 8, the subscriber station can recognize a basic CID and a primary management CID uniquely allocated thereto. Further, in the initial ranging procedure, because the subscriber station randomly selects a ranging slot and a ranging code and transmits the randomly selected ranging code for the randomly selected ranging slot, the same ranging codes transmitted by different subscriber stations may collide with each other at one ranging slot. When ranging codes collide with each other in this way, the base station cannot identify the collided ranging codes, and thus cannot also transmit the RNG-RSP message. In addition, because the RNG-RSP message cannot be received from the base station, the subscriber station repeats transmission of a ranging code for the initial ranging after waiting for a backoff value corresponding to the exponential random backoff algorithm.

If a minimum window size and a maximum window size used in the exponential random backoff algorithm are defined as MIN_WIN and MAX_WIN, respectively, the subscriber station randomly selects one ranging slot among 2^{MIN}^{_{—}}^{WIN} ranging slots during first ranging code transmission, and transmits a ranging code for the selected ranging slot. If ranging code collision occurs during the first ranging code transmission, the subscriber station randomly selects one ranging slot again among ranging slots from the corresponding ranging slot to ranging slots following a (2^{MIN}^{_{—}}^{WIN+1})^{th} ranging slot during second ranging code transmission, and transmits a ranging code for the selected ranging slot.

If ranging code collision occurs during the second ranging code transmission, the subscriber station randomly selects one ranging slot again among ranging slots from the corresponding ranging slot to ranging slots following a (2^{MIN}^{_{—}}^{WIN+2})^{th} ranging slot during third ranging code transmission, and transmits a ranging code for the selected ranging slot. Accordingly, when a subscriber station randomly selects one ranging slot from 2^{k} ranging slots, the ‘k’ is defined as a window size. The window size k used during the ranging code retransmission process is increased one by one from MIN_WIN until the ranging code transmission is successful, i.e., until an RNG-RSP message is received, and window size k is increased until it reaches the maximum window size MAX_WIN.

Periodic Ranging Procedure

FIG. 9 is a flow diagram illustrating a periodic ranging procedure in an OFDM/OFDMA BWA communication system. Referring to FIG. 9, a subscriber station 920 receives an Uplink Channel Descript (UCD) message from a base station 900, and detects a ranging code used for periodic ranging and modulation/demodulation information from the received UCD message. Further, the subscriber station 920 receives a UL-MAP message from the base station 900 in Step 901, and detects a ranging channel and a ranging slot used for periodic ranging from the UL-MAP message.

Thereafter, the subscriber station 920 selects a random ranging code from a periodic ranging code set and transmits the selected ranging code for a particular one ranging slot in Step 903. If the base station 900 identifies the ranging code transmitted by the subscriber station 920, the base station 900 broadcasts the received ranging code and its corresponding ranging slot, and timing/frequency/power adjustment parameters through an RNG-RSP message in Step 905.

The subscriber station 920 adjusts timing/frequency/power offset through the RNG-RSP message corresponding to the ranging code and ranging slot transmitted by the subscriber station 920. Although one ranging slot includes two symbols in the initial ranging procedure, one ranging slot includes one symbol in the periodic ranging procedure. In addition, because a basic CID and a primary management CID are allocated in the initial ranging procedure, a process of allocating CIDs is omitted in the periodic ranging procedure.

If a status value of the RNG-RSP message transmitted by the base station 900 represents ‘Continue’, the subscriber station 920 stores the status value as Continue. In this case, the base station 900 repeats the periodic ranging procedure for the subscriber station 920 during transmission of a next UL-MAP message. Therefore, the base station 900 transmits a UL-MAP message to the subscriber station 920 in Step 907, and the subscriber station 920 detects a ranging channel and a ranging slot used for periodic ranging from the UL-MAP message.

As described above, the subscriber station 920 selects a random ranging code from a periodic ranging code set and transmits the selected ranging code for a random ranging slot in Step 909. If the base station 900 identifies the ranging code transmitted by the subscriber station 920, the base station 900 broadcasts the received ranging code and its corresponding ranging slot, and timing/frequency/power adjustment parameters through an RNG-RSP message in Step 911. Thereafter, the subscriber station 920 adjusts timing/frequency/power offset through the RNG-RSP message corresponding to the ranging code and ranging slot transmitted by the subscriber station 920.

If a status value of the RNG-RSP message transmitted by the base station 900 represents ‘Success’, the subscriber station 920 stores the status value as Success. In this case, the base station 900 ends the periodic ranging procedure for the subscriber station 920. In the periodic ranging procedure, because the subscriber station 920 repeatedly performs data transmission, the base station 900 and the subscriber station 920 repeat the periodic ranging procedure every predetermined time period.

Bandwidth Request Ranging Procedure

The bandwidth request ranging is ranging used to request bandwidth allocation to actually perform communication with a base station by a subscriber station that has adjusted a time offset with the base station and transmission power through the initial ranging.

FIG. 10 is a flow diagram illustrating a bandwidth request ranging procedure in an OFDM/OFDMA BWA communication system. Referring to FIG. 10, a subscriber station 1020 randomly selects one ranging code among ranging codes used for the bandwidth request ranging, randomly selects one ranging slot among ranging slots used for the bandwidth request ranging, and transmits the selected ranging code to a base station 1000 through the selected ranging slot in Step 1001. If the subscriber station 1020 fails to receive a separate response from the base station 1000 even though it transmitted the ranging code, the subscriber station 1020 once again randomly selects one ranging code from the ranging codes used for the initial ranging, randomly selects one ranging slot from the ranging slots used for the bandwidth request ranging, and transmits the selected ranging code to the base station 1000 through the selected ranging slot in Steps 1003 and 1005. Of course, if the subscriber station 1020 receives from the base station 1000 a response to the ranging code transmitted in step 1001, steps 1013 and 1015 are skipped.

Upon receiving a random ranging code through a random ranging slot from the subscriber station 1020, the base station 1000 transmits a UL-MAP message including CDMA Allocation IE to the subscriber station 1020 in Step 1007. The CDMA Allocation IE includes information on an uplink bandwidth at which the subscriber station 1020 will transmit a bandwidth request (BW-REQ) message. The subscriber station 1020 receiving the UL-MAP message from the base station 1000 detects CDMA Allocation IE included in the UL-MAP message, and transmits a BW-REQ message to the base station 1000 using uplink resource, or the uplink bandwidth, included in the CDMA Allocation IE in Step 1009.

The base station 1000 receiving the BW-REQ message from the subscriber station 1020 allocates an uplink bandwidth for data transmission by the subscriber station 1020. Further, the base station 1000 transmits to the subscriber station 1020 a UL-MAP message including information on an uplink bandwidth allocated for data transmission by the subscriber station 1020 in Step 1011. The subscriber station 1020 receiving the UL-MAP message from the base station 1000 recognizes the uplink bandwidth allocated for data transmission, and transits data to the base station 1000 through the uplink bandwidth in Step 1013.

After performing the bandwidth request ranging procedure in the manner described in conjunction with FIG. 10, the subscriber station can transmit data to the base station. In the bandwidth request ranging procedure, as described in the initial ranging procedure, because the subscriber station randomly selects a ranging slot and a ranging code and transmits the randomly selected ranging code for the randomly selected ranging slot, the same ranging codes transmitted by different subscriber stations may collide with each other at one ranging slot. When ranging codes collide with each other in this way, the base station cannot identify the collided ranging codes, and thus cannot allocate an uplink bandwidth. In addition, because the subscriber station cannot be allocated an uplink bandwidth from the base station, the subscriber station repeats transmission of a ranging code for the bandwidth request ranging after waiting for a backoff value corresponding to the exponential random backoff algorithm.

FIG. 11 is a diagram schematically illustrating a backoff procedure during initial ranging, periodic ranging, and bandwidth request ranging in a conventional OFDMA communication system. However, before a description of FIG. 11 is given, it should be noted that although the backoff procedure of FIG. 11 can be applied to all of the initial ranging procedure, the periodic ranging procedure, and the bandwidth request ranging procedure. The backoff procedure will be applied herein to the initial ranging procedure for the convenience of explanation.

Referring to FIG. 11, one frame includes L ranging slots for initial ranging. Three subscriber stations transmit ranging codes at a 3^{rd} ranging slot among the L ranging slots, and the three subscriber stations transmit ranging codes at an L^{th} ranging slot. Here, the three subscriber stations transmitting ranging codes at the 3^{rd} ranging slot will be referred to as a first subscriber station 1101, a second subscriber station 1103, and a third subscriber station 1105, respectively. Further, the three subscriber stations transmitting ranging codes at the L^{th} ranging slot will be referred to as a fourth subscriber station 1107, a fifth subscriber station 1109, and a sixth subscriber station 1111, respectively.

At the 3^{rd} ranging slot, the first subscriber station 1101 transmits a ranging code #1, and the second and third subscriber stations 1103 and 1105 transmit ranging codes #2. Accordingly, when ranging codes are transmitted using the same ranging codes, i.e., the ranging codes #2, at the same ranging slot, the ranging codes #2 collide with each other, such that the base station cannot recognize the ranging codes #2 (See 1120).

As described above, data transmitted by a plurality of subscriber stations at the same slot (or same time) can be distinguished by the ranging codes (for example, PN codes). However, if different subscriber stations transmit data using the same code at the same time, the base station cannot distinguish the data transmitted individually by the subscriber stations.

Therefore, the second subscriber station 1103 and the third subscriber station 1105 cannot receive separate responses from the base station, and perform backoff according to the exponential random backoff algorithm. That is, the second subscriber station 1103 transmits a ranging code using a ranging code #3 at a 4^{th} ranging slot of a second frame (1115), and the third subscriber station 1105 transmits a ranging code using the ranging code #2 again at a 2^{nd} ranging slot of the second frame (1113).

At the L^{th} ranging slot, the fourth subscriber station 1107 and the fifth subscriber station 1109 transmits ranging codes #1, and the sixth subscriber station 1111 transmits a ranging code #3. Accordingly, when ranging codes are transmitted using the same ranging codes, i.e., the ranging codes #1, at the same ranging slot, the ranging codes #1 collide with each other, such the base station cannot recognize the ranging codes #1 (1130). Therefore, the fourth subscriber station 1107 and the fifth subscriber station 1109 cannot receive separate responses from the base station, and perform backoff according to the exponential random backoff algorithm. Although backoffs for the fourth subscriber station 1107 and the fifth subscriber station 1109 are not separately illustrated in FIG. 11, they are identical in operation to the backoffs for the second subscriber station 1103 and the third subscriber station 1105.

In the OFDMA communication system, a subscriber station randomly selects ranging slots and ranging codes for initial ranging, periodic ranging, and bandwidth request ranging during the initial ranging, periodic ranging, and bandwidth request ranging, thereby causing frequent ranging code collisions. The ranging code collisions prevent the base station from recognizing a ranging code for the subscriber station, and the base station cannot perform an operation any longer.

Although the subscriber station performs backoff according to the exponential random backoff algorithm due to the ranging code collision, transmission of a ranging code by the backoff may also cause collisions, leading to an access delay to the base station by the subscriber station. The access delay causes performance degradation of the OFDMA communication system.

In the periodic ranging procedure, a time from first ranging code transmission by the subscriber station to first RNG-RSP message transmission by the subscriber station can be defined as an “access delay time.” In the bandwidth request ranging procedure, a time required from first ranging code transmission to a time when information indicating successful ranging is detected from CDMA Allocation IE in a UL-MAP message received can be defined as an “access delay time.”

In the IEEE 802.16a OFDMA communication system, because the periodic ranging and the bandwidth request ranging utilize Random Access technology for transmitting a random ranging code at a random ranging slot, occurrence of ranging code collision increases an access delay time through a reconnection procedure after exponential random backoff. Therefore, the maximum access delay time cannot be guaranteed. More specifically, as a code collision rate is higher, an access delay time becomes longer, resulting in performance degradation of the system.

### SUMMARY OF THE INVENTION

It is, therefore, an object of the present invention to provide a method for transmitting a ranging code without collisions between subscriber stations in an OFDMA BWA mobile communication system.

It is another object of the present invention to provide a method for transmitting a ranging code without a time delay caused by backoff in an OFDMA BWA mobile communication system.

It is further another object of the present invention to provide a method for grouping and allocating transmission times of ranging codes according to subscriber stations, allocating types of ranging codes to be transmitted, and efficiently transmitting the ranging codes in an OFDMA BWA mobile communication system.

In accordance with one aspect of the present invention, there is provided a method for transmitting a ranging code from a base station to subscriber stations to prevent collisions during a random access by the subscriber stations in an Orthogonal Frequency Division Multiplexing/Orthogonal Frequency Division Multiple Access (OFDM/OFDMA) communication system. The method includes the steps of allocating connection identifiers (CIDs) for identifying the subscriber stations; allocating group IDs to the CIDs to divide the subscriber stations into a predetermine number of groups; and allocating ranging codes for distinguishing subscriber stations in a group corresponding to each of the allocated group IDs.

In accordance with another aspect of the present invention, there is provided a method for transmitting a ranging code to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust time synchronization, frequency synchronization, or a power level between the base station and the subscriber station. The method includes the steps of receiving a connection ID (CID) allocated to the subscriber station from the base station; determining a transmission time of a ranging code by the subscriber station and a type of the ranging code, from the CID; and transmitting the determined ranging code to the base station at the determined ranging code transmission time.

In accordance with further another aspect of the present invention, there is provided a method for transmitting a ranging code to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust time synchronization, frequency synchronization, or a power level between the base station and the subscriber station. The method includes the steps of receiving a connection ID (CID) allocated to the subscriber station from the base station; allocating a transmission time of the ranging code to a plurality of transmission groups, and determining a transmission time of the ranging code for the subscriber station as one of the transmission groups according to the received CID; determining a type of the transmission ranging code such that the subscriber stations should have different ranging codes in the same transmission group; and transmitting the determined ranging code at a transmission time corresponding to the determined transmission group.

In accordance with yet further aspect of the present invention, there is provided a method for transmitting a ranging code to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust time synchronization, frequency synchronization, or a power level between the base station and the subscriber station. The method includes the steps of allocating by the base station a transmission time of the ranging code to a plurality of transmission groups, and receiving information on a transmission time of the ranging code for the subscriber station, determined as one of the transmission groups according to a connection ID (CID) of the subscriber station; receiving information on a type of the transmission ranging code determined such that the subscriber stations should have different ranging codes in the same transmission group; and transmitting the determined ranging code at a transmission time corresponding to the determined transmission group.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram schematically illustrating a configuration of an OFDM/OFDMA Broadband Wireless Access (BWA) communication system;

FIG. 2 is a diagram illustrating a frame configuration of an OFDM/OFDMA BWA communication system in a time-frequency domain;

FIG. 3 is a diagram schematically illustrating a downlink frame configuration for an OFDM/OFDMA BWA communication system;

FIG. 4 is a diagram schematically illustrating a configuration of an uplink frame for an OFDM/OFDMA BWA communication system;

FIG. 5 is a diagram illustrating a structure of a ranging code generator in a general OFDMA/OFDMA BWA communication system;

FIG. 6 is a diagram schematically illustrating a communication procedure in an OFDM/OFDMA BWA communication system;

FIG. 7 is a diagram schematically illustrating a communication procedure in an OFDM/OFDMA BWA communication system;

FIG. 8 is a flow diagram illustrating an initial ranging procedure in an OFDM/OFDMA BWA communication system;

FIG. 9 is a flow diagram illustrating a periodic ranging procedure in an OFDM/OFDMA BWA communication system;

FIG. 10 is a flow diagram illustrating a bandwidth request ranging procedure in an OFDM/OFDMA BWA communication system;

FIG. 11 is a diagram schematically illustrating collision occurring during an uplink access in an OFDM/OFDMA BWA communication system;

FIG. 12 is a diagram illustrating a method for allocating group numbers to slots in each frame according to an embodiment of the present invention;

FIG. 13 is a diagram illustrating a method for attempting an uplink access by group allocation according to an embodiment of the present invention;

FIG. 14 is a flowchart illustrating a procedure for attempting an uplink access by group allocation according to an embodiment of the present invention;

FIG. 15 is a flow diagram illustrating a procedure for attempting an uplink access by calculating a group ID according to an embodiment of the present invention; and

FIG. 16 is a flow diagram illustrating a procedure for attempting an uplink access by transmitting a group ID according to an embodiment of the present invention.

### DETAILED DESCRIPTION OF THE PREFERRED EMBODIMENT

Several preferred embodiments of the present invention will now be described in detail herein below with reference to the annexed drawings. In the following description, a detailed description of known functions and configurations incorporated herein has been omitted for conciseness.

The present invention provides a method for transmitting ranging codes without ranging code collisions, while minimizing an access delay time in a communication system supporting Orthogonal Frequency Division Multiple Access (OFDMA) technology (hereinafter referred to as “OFDMA communication system”).

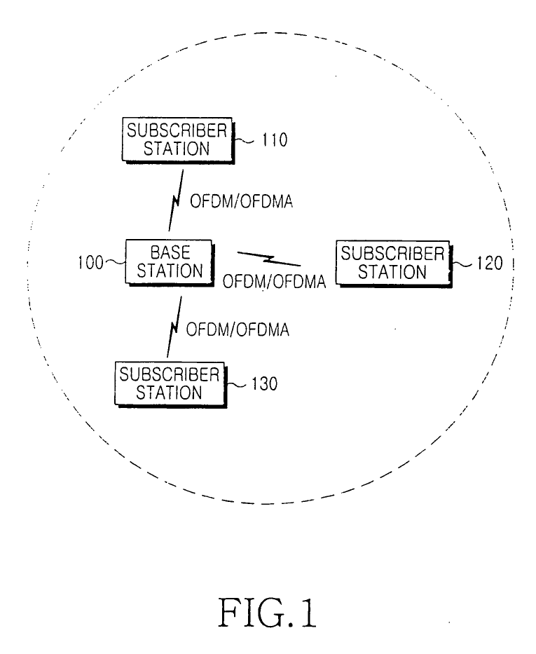

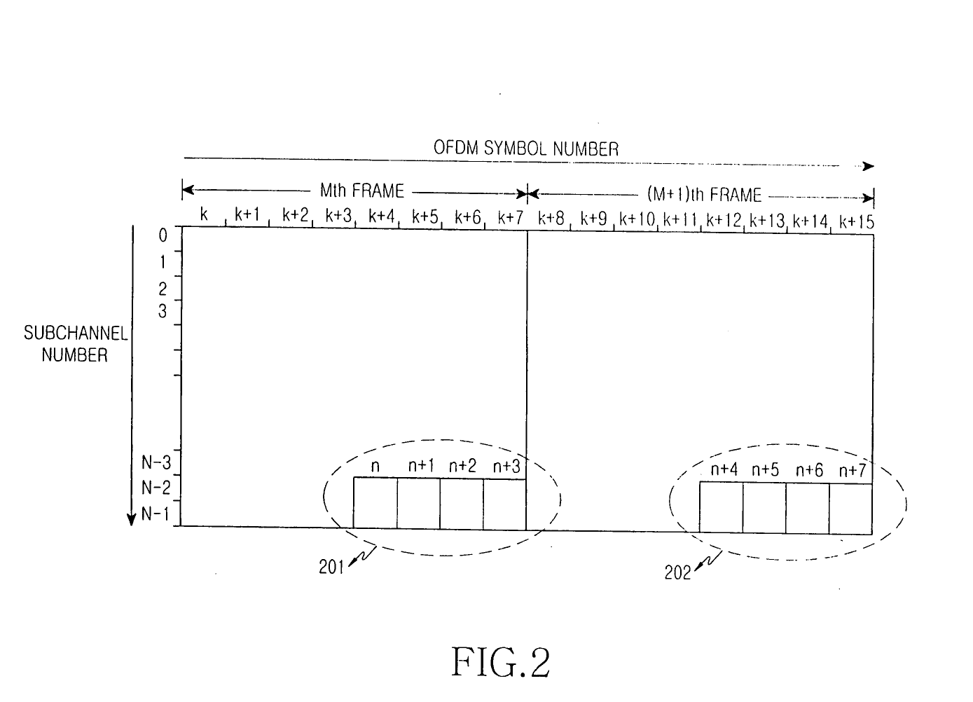

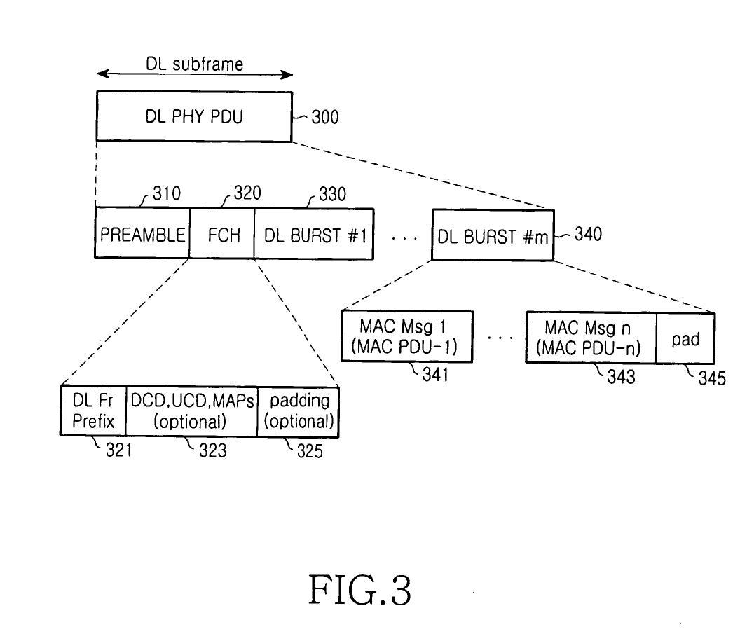

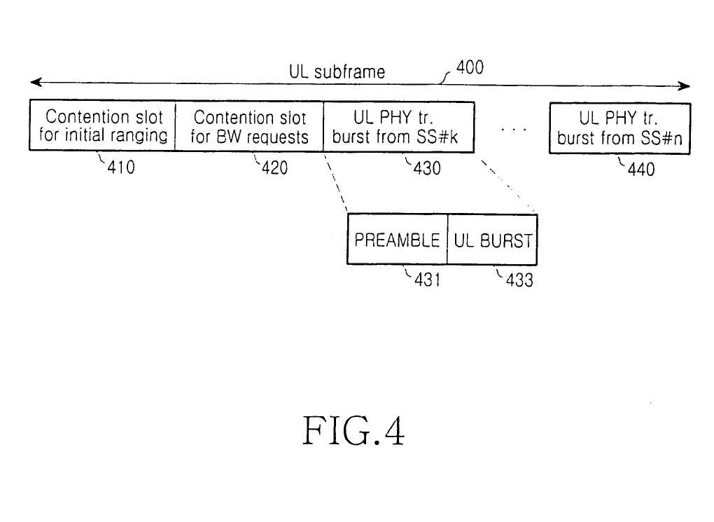

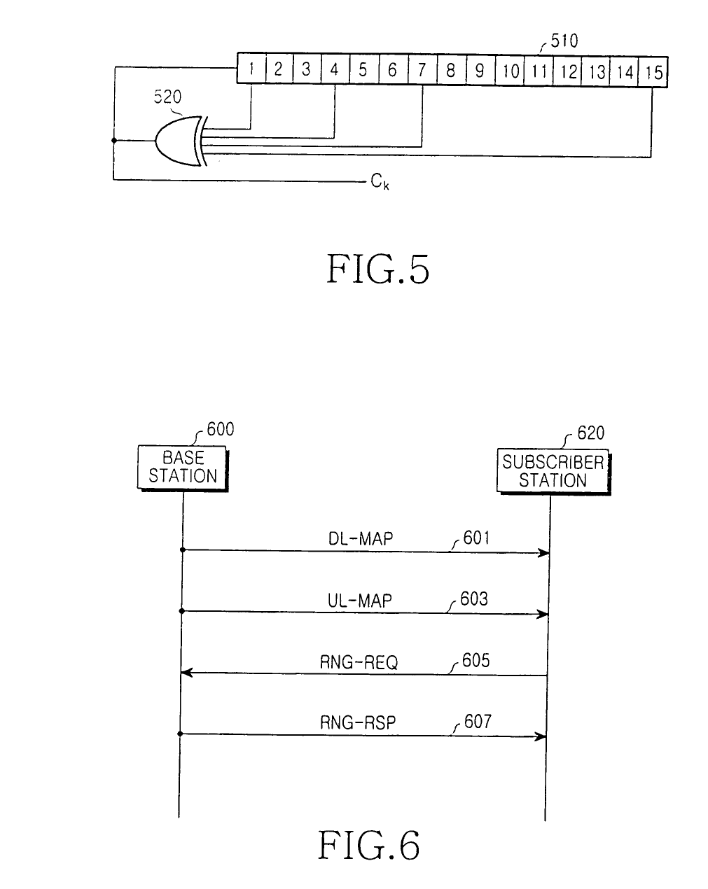

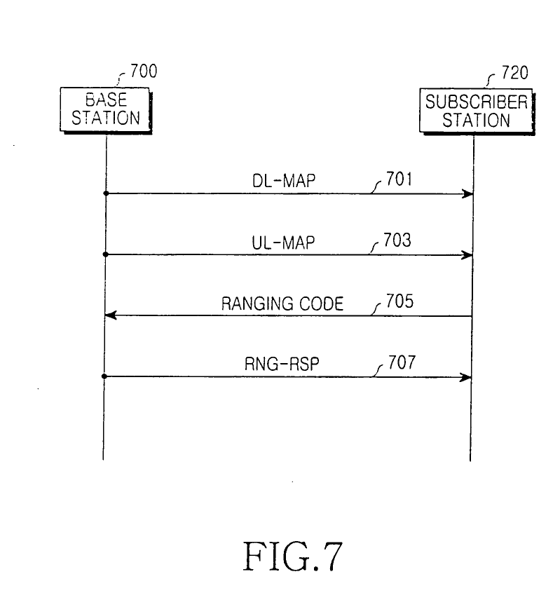

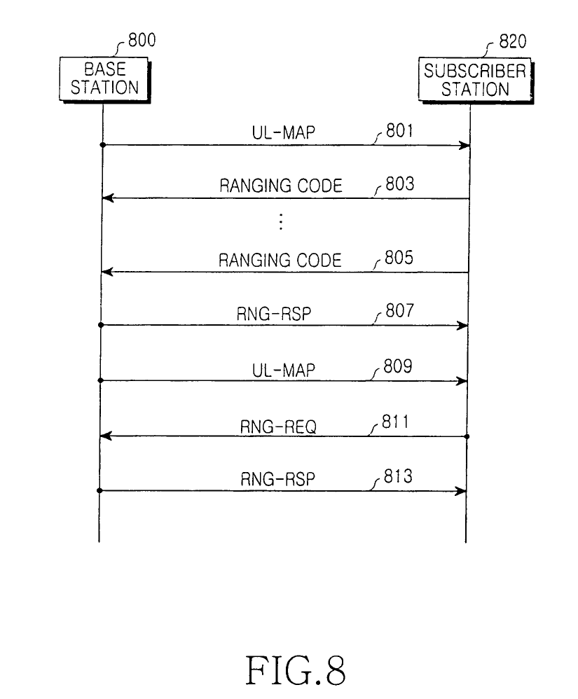

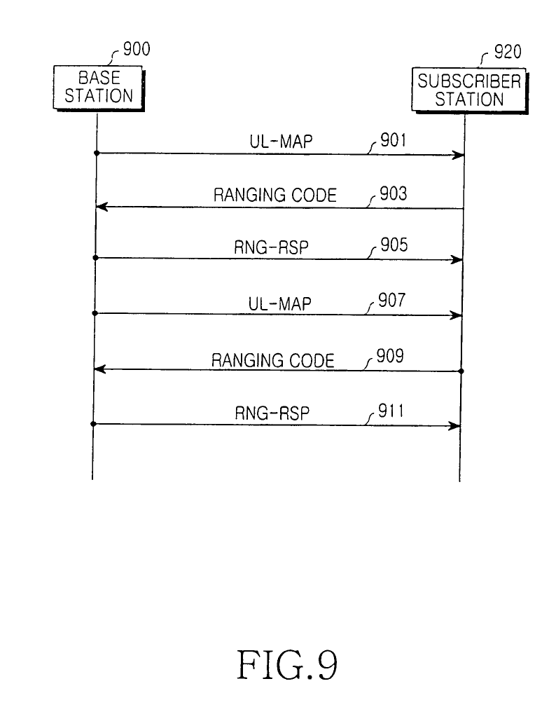

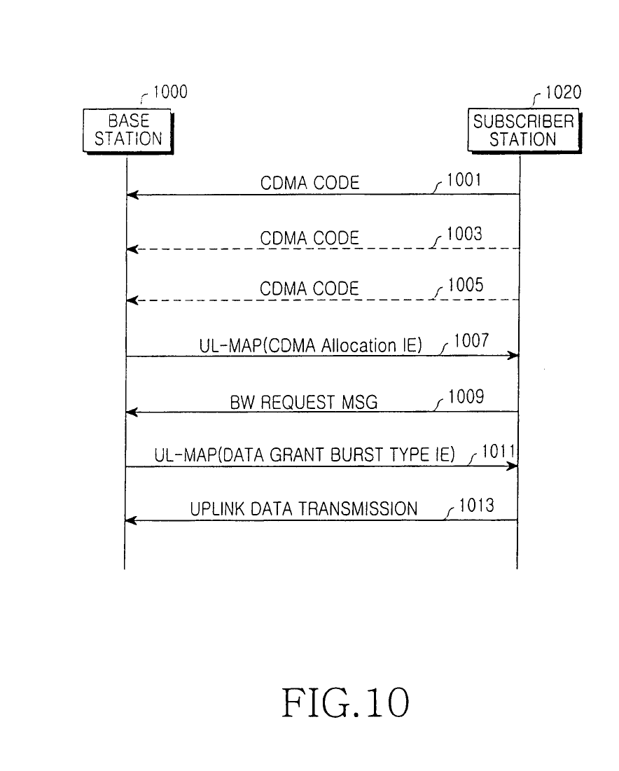

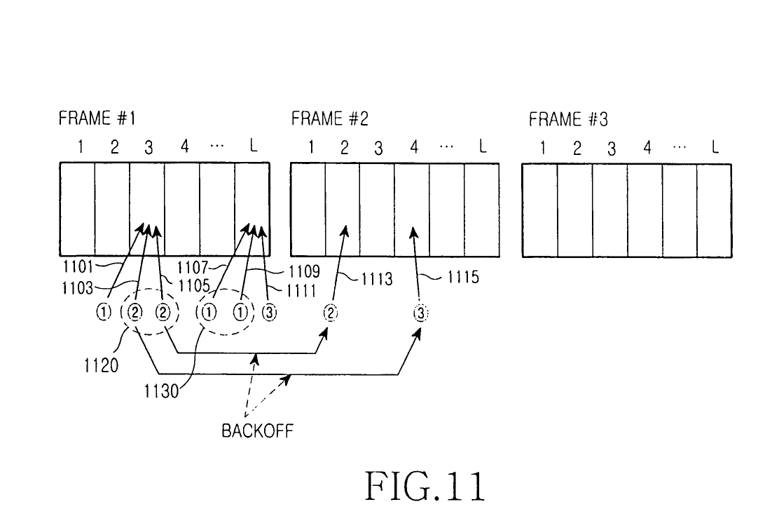

In the following description, it will be assumed that the OFDMA communication system is identical in configuration to the IEEE 802.16a communication system of FIG. 1 described in the Related Art section, and the OFDMA frame is also identical in configuration to the OFDMA frame of FIG. 2 described in the Related Art section. Also, the present invention can be applied to an IEEE 802.16e communication system, which considers the mobility of a subscriber station in the IEEE 802.16a communication system.

In the present invention, in order to prevent collisions between ranging codes for subscriber stations, which may occur when uplink ranging codes are randomly transmitted in a ranging procedure, a ranging code transmission time (for example, a particular ranging slot) and a ranging code are previously allocated for each subscriber station (SS). That is, by allocating different ranging codes to a plurality of subscriber stations desiring to make an uplink random access according to ranging slots, it is possible to prevent an uplink access from being made with same ranging codes at the same ranging slot between different subscriber stations.

In order to allocate a different ranging code transmission time and a different ranging code to each subscriber station, the present invention uses a connection ID (CID) that is uniquely allocated to each subscriber station.

In addition, by allocating group numbers to the ranging slots, each subscriber station is prevented from using the same ranging code in the same group.

More specifically, the present invention provides an efficient uplink access method for use in a periodic ranging procedure and a bandwidth request ranging procedure in a situation in which a plurality of subscriber stations request access to one base station in a wireless cellular system.

The uplink access method proposed in the present invention includes:
step 1: a base station allocates CID (basic CID or primary management CID) to each subscriber station through initial ranging.

step 2: the subscriber station is allocated a group ID.

step 3: the subscriber station is allocated a ranging code.

step 4: the base station and the subscriber station determine a ranging slot corresponding to the group ID.

step 5: the subscriber station transmits the allocated ranging code at a ranging slot allowed thereto.

step 6: the base station identifies a ranging code transmitted at each ranging slot and sends a response to the subscriber station.

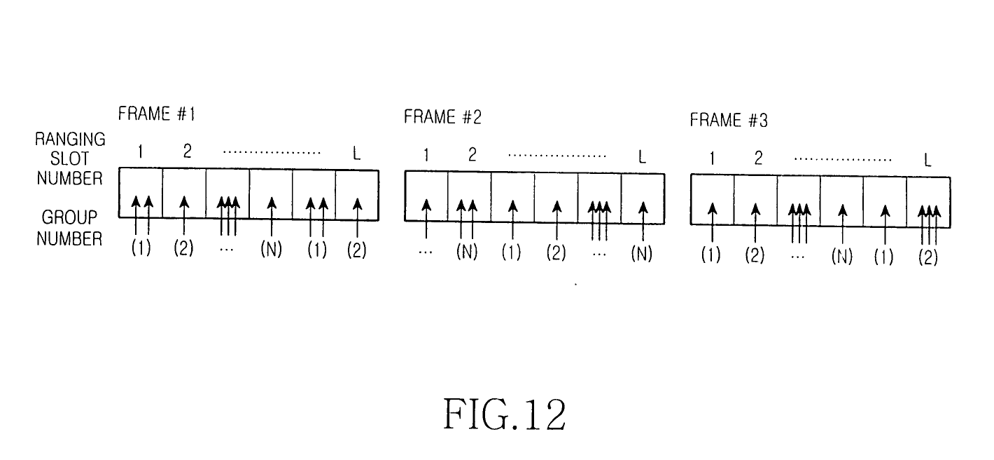

FIG. 12 is a diagram illustrating a method for allocating group numbers to slots in each frame according to an embodiment of the present invention. It is assumed herein that an OFDMA system transmits data on a frame-by-frame basis, and one frame includes a plurality of slots, e.g., L. Further, uplink ranging codes are transmitted at one ranging slot among a plurality of ranging slots.

According to the present invention, group numbers are allocated to a plurality of slots constituting one frame. For example, when the L ranging slots are divided into N groups (where N<L), the ranging slots can be allocated to a group #1 to a group #N as illustrated in FIG. 12. When the group numbers are allocated to the subscriber stations, ranging slot numbers mapped to the group numbers are determined and the subscriber stations determine ranging codes through the ranging slots corresponding to the group numbers. According to the present invention, it is preferable to allocate group numbers as well as ranging codes to the subscriber stations so that the subscriber stations cannot use the same ranging code at the same ranging slot.

For example, in FIG. 12, there is a first frame, a second frame, and a third frame, and L slots included in each frame are allocated a group number #1 to a group number #N.

A particular subscriber station allocated the group number must transmit an allocated ranging code through a particular ranging slot corresponding to the allocated group number. For example, if a subscriber station is allocated a group number #2, the subscriber station must transmit an allocated particular ranging code through a second ranging slot of the first frame, a fourth ranging slot of the second frame, or a second ranging slot of the third frame.

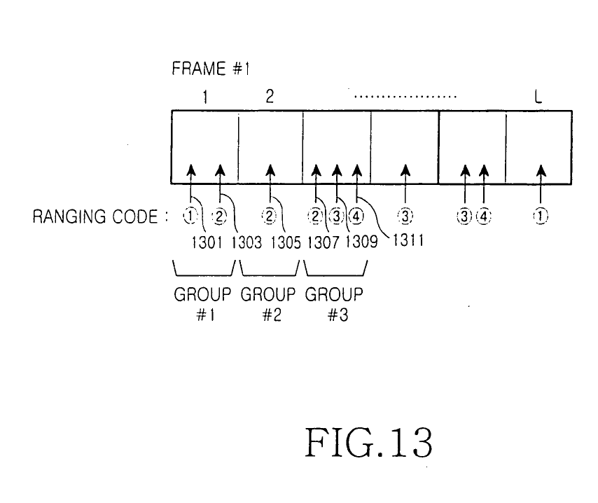

FIG. 13 is a diagram illustrating a method for attempting an uplink access by group allocation according to an embodiment of the present invention. For simplicity, FIG. 13 illustrates an example of an uplink access attempt in one frame (for example, the first frame) illustrated in FIG. 12.

Referring to FIG. 13, one frame includes L ranging slots, and the ranging slots are allocated group numbers. For example, a first ranging slot is assigned a group number #1, a second ranging slot a group number #2, and a third ranging slot a group number #3. Accordingly, the first ranging slots to the L^{th} ranging slot are assigned group numbers.

Subscriber stations transmitting ranging codes through the same group are allocated different ranging codes. Therefore, referring to FIG. 13, at a first group, i.e., the first ranging slot, a subscriber station 1301 using a first ranging code and a subscriber station 1303 using a second ranging code transmit their ranging codes. At a second group, i.e., the second ranging slot, a subscriber station 1305 using a second ranging code transmits the ranging code. At a third group, i.e., the third ranging slot, subscriber stations 1307, 1309 and 1311 using second, third and fourth ranging slots, respectively, transmit their ranging codes.

Because the subscriber stations transmitting the ranging codes are allocated different ranging codes according to group numbers, there is no such a case that the same ranging codes are used in the same group. For example, in no case will subscriber stations simultaneously transmit the same first ranging codes or the same second ranging codes in the first group, which happened in the conventional technology. According to the present invention, the backoff, which inevitably occurs in a general random access, is prevented, remarkably reducing an uplink access time and contributing to efficient uplink access without collision.

Uplink Access Procedure

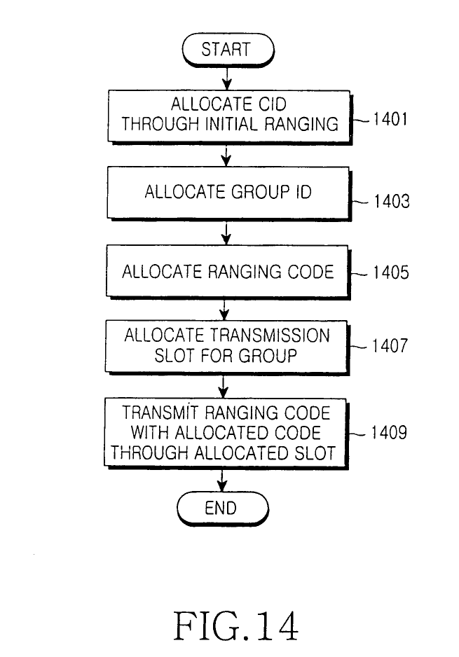

FIG. 14 is a flowchart illustrating a procedure for attempting an uplink access by group allocation according to an embodiment of the present invention. Referring to FIG. 14, a subscriber station desiring to attempt an uplink access is allocated a CID through initial ranging in Step 1401. The subscriber station allocated a CID (for example, a basic CID) is allocated a group ID from the CID through a predetermined operation (for example, modulo operation) in Step 1403. In addition, the subscriber station allocated a group ID is allocated a ranging code such that the same ranging codes should not be duplicated in each group through the CID in Step 1405. That is, because the CID can identify a subscriber station attempting an uplink access in a particular cell, the subscriber station can be allocated its unique group ID and ranging code.

As described above in connection with FIGS. 12 and 13, according to the group ID, the subscriber station is allocated a particular ranging slot of a particular frame as a transmission slot for an uplink ranging code in Step 1407. That is, the transmission slot is determined according to the group ID.

The subscriber station that is allocated a ranging code and a transmission slot for its group in steps 1405 and 1407 transmits a ranging code through the corresponding ranging slot with the allocated ranging code in Step 1409. As a result, no collisions occur even when a plurality of subscriber stations attempt an uplink access, thereby preventing the backoff and thus contributing to efficient transmission of ranging codes.

The above-described steps will be described in more detail herein below. It should be noted, however, that the parameters used in the following description are provided for better understanding of the present invention, and can be replaced with other equivalent parameters.

CID Allocation in Step 1401

In the IEEE 802.16a/IEEE 802.16e communication system, a connection between a subscriber station and a base station should first be set up in order for the subscriber station to receive a communication service from the base station, and a connection ID (CID) for identifying the connection is allocated by the base station. The CID is classified into an Initial Ranging CID, a Basic CID, a Primary Management CID, a Secondary Management CID, a Transport CID, a Multicast Polling CID, a Padding CID, and a Broadcast CID according to its usage. In the present invention, because the CID is classified for each subscriber station and it is preferable to use a CID previously allocated for initial ranging, the Basic CID, Primary Management CID, or Secondary Management CID can be used. The Basic CID, Primary Management CID, and Secondary Management CID are CIDs that are fundamentally allocated when each subscriber station accesses a base station.

Group ID Allocation in Step 1403

In a method for allocating a group ID to a subscriber station, a base station and a subscriber station share a predetermined algorithm such that the subscriber station can calculate a group ID by itself through the allocated CID. Alternatively, the base station can determine a group ID by a self group ID allocation method and inform the subscriber station of the determined group ID.

Ranging Code Allocation in Step 1405

Similarly, in a method for allocating a ranging code, as described in the method for allocating a group ID, a base station and a subscriber station share a predetermined algorithm in order for the subscriber station can calculate a ranging code by itself through the allocated CID. Alternatively, the base station can determine a ranging code by a self ranging code allocation method and inform the subscriber station of the determined ranging code.

That is, the subscriber station determines its own group ID and ranging code from the CID through a predetermined rule (for example, modulo operation), or the base station determines the group ID and ranging code and transmits information on the determined group ID and ranging code to the subscriber station. Alternatively, the group ID and ranging code are calculated by an algorithm shared by the base station and the mobile station.

An algorithm for calculating the group ID and ranging code from the CID can be implemented through the following modulo operation. For example, if the number of groups for uplink transmission is N, a remainder obtained by dividing a CID of the subscriber station by N is defined as a group ID and a quotient obtained by dividing the CID by N can be allocated as a ranging code, as expressed in Equation (1),
CID=α_{code}·N+β_{G}_{_{—}}_{ID} (1)
where α_{code} denotes a unique number of a ranging code, and β_{G}_{_{—}}_{ID} denotes a group ID.

Referring to Equation (1), because each subscriber station is allocated a unique CID, the subscriber station can be allocated its unique ranging code for each of N groups. For example, if a CID of the subscriber station is 243 and ranging slots are divided into 20 groups, the CID of the mobile station becomes 243=12×20+3, such that the subscriber station allocated the CID of 243 transmits a ranging code #12 through a 3^{rd} group among ranging slots mapped to a 1^{st} group to a 20^{th} group.

As can be understood from Equation (1), it is preferable to properly select the number of groups considering an uplink transmission time, the number of ranging codes available in one slot, and the number of subscriber stations belonging to a corresponding cell.

Allocation of Transmission Slots for Each Group in Step 1407

Ranging slots are mapped to one group as illustrated in connection to FIG. 12. The base station and the subscriber station can use a predetermined mapping relation between a ranging slot and a group ID. Alternatively, the base station can broadcast the mapping relation between a ranging slot and a group ID through a predetermined message (for example, UL-MAP message) transmitted to the subscriber station.

As described above, it is preferable that the ranging slots are equally allocated to the groups. A method for allocating the ranging slots to the groups can be implemented with a method for allowing the subscriber station and the base station to share a counter.

For example, the base station and the subscriber station share a synchronized counter having a value between 0 and (N−1), and the base station can periodically broadcast the counter value to the subscriber station for synchronization between counters. In addition, the counter increases by one every ranging slot, and sets a value after (N−1) to 0. Therefore, a mapping relation between a ranging slot and a group ID is formed as illustrated in FIG. 12.

Transmission of Ranging Code by Subscriber Station in Step 1409

In case of periodic ranging or bandwidth request ranging, the subscriber station attempts an uplink access using the ranging code and group ID allocated in steps 1405 and 1407. That is, if a group ID is i (0≦i≦N−1), the allocated ranging code is transmitted at a ranging slot where the counter value is i.

The base station identifies ranging codes transmitted from a plurality of subscriber stations every ranging slot, and transmits a response message (for example, RNG-RSP message) to a corresponding subscriber station. According to the present invention, because there are no collisions between ranging codes transmitted by subscriber stations at a particular ranging slot, all of the subscriber stations that transmitted the ranging codes can receive a response without backoff. Because it is possible to transmit a response without backoff as stated above, no time delay occurs in the periodic ranging or bandwidth request ranging procedure.

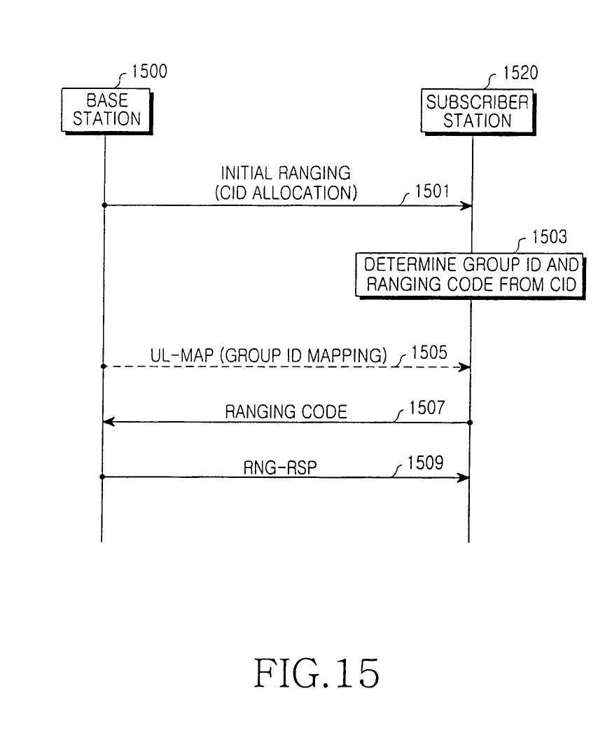

FIG. 15 is a flow diagram illustrating a procedure for attempting an uplink access by calculating a group ID according to an embodiment of the present invention. Referring to FIG. 15, a subscriber station 1520 is allocated a CID (for example, Basic CID, Primary Management CID, or Secondary Management CID) from a base station 1500 during initial ranging in Step 1501. The subscriber station 1520 determines a group ID and a ranging code from the received CID in the manner described above in Step 1503. A method for determining a group ID and a ranging code from the received CID (for example, algorithm) should also be known to the base station 1500. Accordingly, the base station 1500 determines a subscriber station from which a particular ranging code transmitted at a particular ranging slot is transmitted.

A CID is uniquely allocated to each subscriber station by the base station 1500, and because a group ID and a ranging code are determined through the CID, it is possible to allocate the CID such that subscriber stations are not simultaneously allocated the same group ID and ranging code.

As described above, the base station 1500 and the subscriber station 1520 activate a counter to acquire synchronization of a ranging slot, and information on a mapping relation between the ranging slot and the group ID is transmitted from the base station 1500 to the subscriber station 1520. The group ID mapping information can be transmitted through a UL-MAP message in Step 1505.

After determining the group ID and ranging code and receiving the mapping information between the group ID and the ranging slot, the subscriber station 1520 transmits the determined ranging code at the determined corresponding ranging slot in Step 1507.

Although the group ID and ranging code corresponding to the subscriber station 1520 are determined herein by the subscriber station 1520, because the base station 1500 also knows a CID for the subscriber station 1520 as stated above, the base station 1500 can determine a subscriber station that transmitted the ranging code, for a particular ranging code received at the particular ranging slot.

Therefore, the base station 1500 receiving the ranging code at the ranging slot transmits a response message (for example, RNG-RSP message) to the corresponding subscriber station 1520 that transmitted the ranging code in Step 1509.

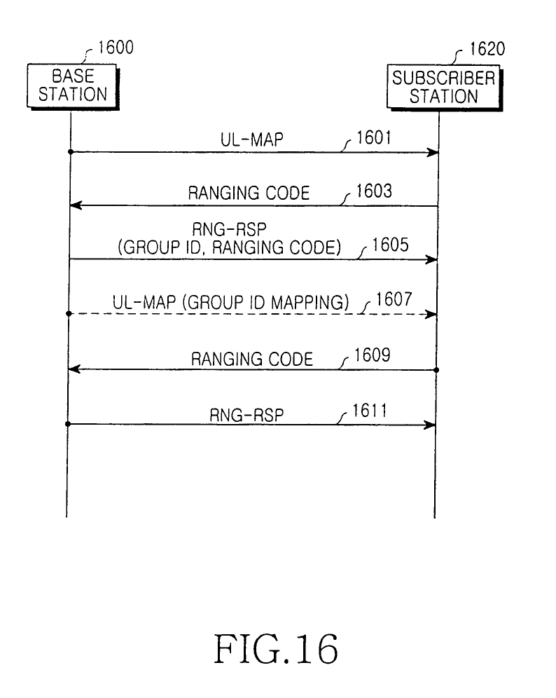

FIG. 16 is a flow diagram illustrating a procedure for attempting an uplink access by transmitting a group ID according to an embodiment of the present invention. Referring to FIG. 16, a base station 1600 broadcasts a UL-MAP message to a plurality of subscriber stations for initial ranging in Step 1601, and a subscriber station 1620 receiving the UL-MAP message determines a transmission period of a ranging code through the UL-MAP message and transmits a ranging code for the determined transmission period in Step 1603.

The base station 1600 receiving the ranging code transmits a response message (for example, RNG-RSP message) indicating normal receipt of the ranging code to the corresponding subscriber station 1620 in Step 1605. In this case, the base station 1600 transmits unique group ID and ranging code for the subscriber station 1620. The group ID and ranging code, as described above, are determined through a CID allocated to the corresponding subscriber station 1620. Therefore, the base station 1600 can allocate unique group ID and ranging code to each subscriber station.

The subscriber station 1620 receiving the group ID and ranging code, as described in conjunction with FIG. 15, activates a counter to acquire synchronization of a ranging slot between the base station 1600 and the subscriber station 1620. Information on a mapping relation between the ranging slot and the group ID is transmitted from the base station 1600 to the subscriber station 1620. The group ID mapping information can be transmitted through a UL-MAP message in Step 1607.

After determining the group ID and ranging code and receiving the mapping information between the group ID and the ranging slot, the subscriber station 1620 transmits the determined ranging code at the determined corresponding ranging slot in Step 1609. Because the base station 1600 already knows a subscriber station that transmits a particular ranging code at the corresponding ranging slot, it transmits a response message (for example, RNG-RSP message) to the subscriber station 1620 that transmitted the ranging code in Step 1611.

Therefore, by previously determining a transmission time of a ranging code for each subscriber station and a ranging code transmitted at the corresponding time, it is possible to previously prevent collisions caused by transmitting the same ranging codes at the same ranging slot. In addition, it is possible to reduce a transmission time caused by backoff due to the collisions.

As can be understood from the foregoing description, the present invention prevents ranging code collisions by allocating a group ID to a subscriber station using a CID allocated during initial ranging and allocating a unique ranging code in a group. In addition, the ranging code collisions are prevented, the base station can identify all ranging codes transmitted, thereby reducing an access delay time.

While the present invention has been shown and described with reference to certain preferred embodiments thereof, it will be understood by those skilled in the art that various changes in form and details may be made therein without departing from the spirit and scope of the invention as defined by the appended claims.

1. A method for transmitting a ranging signal from a base station to subscriber stations to prevent collisions during a random access by the subscriber stations in an Orthogonal Frequency Division Multiplexing/Orthogonal Frequency Division Multiple Access (OFDM/OFDMA) communication system, the method comprising the steps of:
allocating connection identifiers (CIDs) for identifying the subscriber stations;
allocating group IDs to the CIDs to divide the subscriber stations into a predetermine number of groups; and
allocating ranging codes for distinguishing the subscriber stations in a group corresponding to each of the allocated group IDs.

2. The method of claim 1, wherein the transmitted ranging signal is transmitted for periodic ranging.

3. The method of claim 1, wherein the transmitted ranging signal is transmitted for bandwidth request ranging.

4. The method of claim 1, wherein the CID is one of a basic CID, a primary management CID, and a secondary management CID.

5. The method of claim 1, wherein the CID is allocated by the base station, and transmitted to the subscriber station in an initial ranging procedure.

6. The method of claim 5, wherein the CID is transmitted through a ranging response (RNG-RSP) message transmitted from the base station to the subscriber station in the initial ranging procedure.

7. The method of claim 1, wherein a transmission time and a type of the ranging code are determined by receiving the CID by the subscriber station and using a method shared with the base station through the received CID.

8. The method of claim 1, wherein a transmission time and a type of the ranging code are determined from a CID of the subscriber station by the base station, and the determined transmission time and type of the ranging code are transmitted to the subscriber station.

9. The method of claim 1, further comprising the steps of:
mapping a ranging transmission group to a ranging slot for the ranging code; and
allocating the transmission group according to the CID.

10. The method of claim 9, wherein mapping information between the ranging slot and the ranging transmission group is transmitted through an uplink MAP (UL-MAP) message transmitted from the base station to the subscriber station.

11. A method for transmitting a ranging signal to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust at least one of time synchronization, frequency synchronization, and a power level between the base station and the subscriber station, the method comprising the steps of:
receiving a connection ID (CID) allocated to the subscriber station from the base station;
determining a transmission time of a ranging code by the subscriber station and a type of the ranging code, from the CID; and
transmitting the determined ranging code to the base station at the determined ranging signal transmission time.

12. The method of claim 11, wherein the transmitted ranging signal is transmitted for periodic ranging.

13. The method of claim 11, wherein the transmitted ranging signal is transmitted for bandwidth request ranging.

14. The method of claim 11, wherein the CID is one of a basic CID, a primary management CID, and a secondary management CID.

15. The method of claim 11, wherein the CID is allocated by the base station, and transmitted to the subscriber station in an initial ranging procedure.

16. The method of claim 15, wherein the CID is transmitted through a ranging response (RNG-RSP) message transmitted from the base station to the subscriber station in the initial ranging procedure.

17. The method of claim 11, wherein the transmission time of the ranging code and the type of the ranging code are determined by receiving the CID by the subscriber station and using a method shared with the base station through the received CID.

18. The method of claim 11, wherein the transmission time of the ranging signal and the type of the ranging code are determined from a CID of the subscriber station by the base station, and the determined transmission time and type of the ranging code are transmitted to the subscriber station.

19. The method of claim 11, further comprising the steps of:
mapping a ranging transmission group to a ranging slot for transmitting the ranging signal; and
allocating the transmission group to the CID.

20. The method of claim 19, wherein mapping information between the ranging slot and the ranging transmission group is transmitted through an uplink MAP (UL-MAP) message transmitted from the base station to the subscriber station.

21. A method for transmitting a ranging code to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust at least one of time synchronization, frequency synchronization, and a power level between the base station and the subscriber station, the method comprising the steps of:
receiving a connection ID (CID) allocated to the subscriber station from the base station;
allocating a transmission time of the ranging code to a plurality of transmission groups;
determining a transmission time of the ranging code for the subscriber station as one of the transmission groups according to the received CID;
determining a type of the transmission ranging code such that the subscriber stations should have different ranging codes in a same transmission group; and
transmitting the determined ranging code at a transmission time corresponding to the determined transmission group.

22. The method of claim 21, wherein the transmitted ranging code is transmitted for initial ranging.

23. The method of claim 21, wherein the transmitted ranging code is transmitted for bandwidth request ranging.

24. The method of claim 21, wherein the CID is one of a basic CID, a primary management CID, and a secondary management CID.

25. The method of claim 21, wherein the CID is allocated by the base station, and transmitted to the subscriber station in an initial ranging procedure.

26. The method of claim 25, wherein the CID is transmitted through a ranging response (RNG-RSP) message transmitted from the base station to the subscriber station in the initial ranging procedure.

27. The method of claim 21, wherein a transmission group allocated to the transmission time is allocated by a slot for dividing one transmission frame into a plurality of transmission periods.

28. The method of claim 27, wherein mapping information between the ranging slot and the ranging transmission group is transmitted through an uplink MAP (UL-MAP) message transmitted from the base station to the subscriber station.

29. The method of claim 21, wherein the number of transmission groups mapped to the transmission time is determined considering at least one of a number of subscriber stations in a corresponding cell, a maximum delay time, and the number of ranging codes available in one slot.

30. The method of claim 21, wherein types of the transmission group and the ranging code are determined from the CID in accordance with,
CID=α_{code}·N+β_{G}_{_{—}}_{ID}
where α_{code} denotes a unique number of a ranging code, and β_{G}_{_{—}}_{ID} denotes a group ID.

31. A method for transmitting a ranging code to a base station by a subscriber station in a Broadband Wireless Access (BWA) communication system that supports Orthogonal Frequency Division Multiplexing/Orthogonal Frequency Division Multiple Access (OFDM/OFDMA) and transmits ranging information from the base station to the subscriber station to adjust at least one of time synchronization, frequency synchronization, and a power level between the base station and the subscriber station, the method comprising the steps of:
allocating, by the base station, a transmission time of the ranging code to a plurality of transmission groups;
receiving information on a transmission time of the ranging code for the subscriber station, determined as one of the transmission groups according to a connection ID (CID) of the subscriber station;
receiving information on a type of the transmission ranging code determined such that the subscriber stations should have different ranging codes in a same transmission group; and
transmitting the determined ranging code at a transmission time corresponding to the determined transmission group.

32. The method of claim 31, wherein the transmitted ranging code is transmitted for initial ranging.

33. The method of claim 31, wherein the transmitted ranging code is transmitted for bandwidth request ranging.

34. The method of claim 31, wherein the CID is one of a basic CID, a primary management CID, and a secondary management CID.

35. The method of claim 31, wherein the CID is transmitted to the subscriber station in an initial ranging procedure.

36. The method of claim 35, wherein the CID is transmitted through a ranging response (RNG-RSP) message transmitted from the base station to the subscriber station in the initial ranging procedure.

37. The method of claim 31, wherein a transmission group allocated to the transmission time is allocated by a slot for dividing one transmission frame into a plurality of transmission periods.

38. The method of claim 37, wherein mapping information between the ranging slot and the ranging transmission group is transmitted through an uplink MAP (UL-MAP) message transmitted from the base station to the subscriber station.

39. The method of claim 31, wherein the number of transmission groups mapped to the transmission time is determined considering at least one of a number of subscriber stations in a corresponding cell, a maximum delay time, and the number of ranging codes available in one slot.

40. The method of claim 31, wherein types of the transmission group and the ranging code are determined from the CID in accordance with,
CID=α_{code}·N+β_{G}_{_{—}}_{ID}
where α_{code} denotes a unique number of a ranging code, and β_{G}_{_{—}}_{ID} denotes a group ID.
